(19) United States
(12) Patent Application Publication
(10) Pub. No.: US 2026/0133657 A1
(43) Pub. Date: May 14, 2026

(54) TOUCH-SENSING CIRCUIT AND TOUCH-SENSING METHOD THEREOF

(71) Applicant: LX SEMICON CO., LTD., Daejeon (KR)

(72) Inventor: Chan Hee HAN, Daejeon (KR)

(73) Assignee: LX SEMICON CO., LTD., Daejeon (KR)

(21) Appl. No.: 19/118,829

(22) PCT Filed: Oct. 13, 2023
(86) PCT No.: PCT/KR2023/015803

§ 371 Date: Apr. 7, 2025

(30) Foreign Application Priority Data
Oct. 13, 2022 (KR) 10-2022-0131484

(51) Int. Cl. G06F 3/041; G06F 3/044

(52) U.S. Cl. CPC G06F 3/04186; G06F 3/04164; G06F 3/0446

(57) ABSTRACT

According to the present disclosure, reliability may be tested for touches that occur on a panel comprising touch electrodes of mixed-type touch patterns, and actual touches and ghost touches may be distinguished, so that the ghost touches may be eliminated. In addition, according to an aspect, even if the patterns of the touch electrodes are changed, accurate coordinate determination, such as the patterns of an existing touch electrode, is possible through data processing.

### CROSS-REFERENCE TO RELATED APPLICATIONS

This application is a national phase entry of PCT International Application No. PCT/KR 2023/015803 filed on Oct. 13, 2023, which claims the priority of Korean Application No. 10-2022-0131484 filed on Oct. 13, 2022, which are hereby incorporated by reference in their entirety.

### BACKGROUND

### Field of the Disclosure

The aspect relates to a touch-sensing circuit that senses a touch by a touch electrode on a touch panel and a touch-sensing method thereof.

### Description of the Background

Recently, the adoption of a touch panel having a touch function on a display panel is increasing from a small electronic device (e.g., smartphone) to a large electronic device (e.g., TV or electronic blackboard).

A touch panel refers to a transparent switch panel that has a function of operating a device or executing a program by a user pressing text, an image, or an icon. The touch panel may be disposed with touch electrodes TE (or electrodes (EL)) of a certain size according to a specific arrangement method (or a specific pattern).

For example, a plurality of touch electrodes having a certain size may be disposed in a matrix form according to a size of the display device or a size of the touch panel. When a specific object (e.g., a hand or an electronic pen) comes into contact with a plurality of touch electrodes disposed on the touch panel, the contact or proximity of the object may be sensed by each touch electrode. The touch-sensing circuit may determine the location (or touch coordinates) where the object is touched by changes in electrostatic capacity due to the contact or proximity of the object.

The arrangement method of the touch electrode(or pattern of the touch electrode) disposed on the touch panel may be implemented in various forms. Typically, the touch electrodes having the same size may be disposed in a matrix form.

Meanwhile, when the arrangement method of the touch electrodes (or the pattern of the touch electrodes) disposed on the touch panel is changed, the algorithm for determining the touch location (or touch coordinates) may be changed. Accordingly, when the processing method of an existing touch pattern is applied to the changed pattern of the touch electrode, a problem of inaccurate results being output may occur.

### SUMMARY

The present disclosure is to provide a touch-sensing device and a touch-sensing method capable of making accurate coordinate determination, such as the pattern of an existing touch electrode even when the pattern of the touch electrode is changed.

According to one aspect of achieving the above-mentioned, a touch-sensing circuit, comprising: a readout circuit configured to acquire a first touch-sensing value from a first touch electrode having a first region and acquire a second touch-sensing value from second touch electrodes, each of the second touch electrodes having a second region; and a touch microcontroller unit for calculating estimated touch regions based on the first touch-sensing value and the second touch-sensing value, wherein the touch microcontroller unit is configured to determine some of the estimated touch regions as ghost touches and remove the ghost touches.

According to another aspect, a touch-sensing method, comprising: acquiring touch-sensing values from a panel in which touch electrodes of a first pattern and a second pattern are mixed; comparing the touch-sensing values with a reference touch-sensing value to set regions having sensing values higher than the reference touch-sensing value as estimated touch regions; assigning a touch reliability value to each of the estimated touch regions; and determining touch regions in which ghost touches has occurred based on the touch reliability values of the estimated touch regions.

According to another aspect, a touch microcontroller unit, comprising: a touch data acquisition circuit configured to acquire touch-sensing values from a panel having a combination of different patterns; an estimated touch regions calculation circuit configured to acquire two or more estimated touch regions having a reference touch-sensing value or higher based on the touch-sensing values; a touch reliability calculation circuit configured to calculate a touch reliability value for each of the estimated touch regions; and a ghost touch removal circuit configured to determine ghost touches based on the touch reliability values and performs touch-sensing by not recognizing the ghost touches.

As described above, according to the aspect, even if the pattern of the touch electrode is changed, accurate coordinate determination may be performed, such as the pattern of an existing touch electrode through data processing.

According to an aspect, sensing data of a matrix pattern may be acquired from sensing values sensed for a plurality of vertical pattern electrodes and a plurality of horizontal electrode patterns.

According to an aspect, although a relatively smaller number of touch electrodes are disposed for the same area, more precise and accurate determination of touch coordinates may be made by generating more data.

According to an aspect, a ghost touch phenomenon that may occur in a panel having a mixed-type pattern may be effectively eliminated.

### BRIEF DESCRIPTION OF THE DRAWINGS

FIG. 1 is a configuration diagram of a display device according to an aspect.

FIG. 2 is a configuration diagram of a touch-sensing circuit according to an aspect.

FIG. 3 is a configuration diagram of a touch microcontroller unit according to an aspect.

FIG. 4 is a diagram explaining the shape of touch electrodes disposed on a panel.

FIG. 5 is a diagram explaining a process of recognizing a touch by acquiring a touch-sensing value from a panel.

FIG. 6 is a drawing explaining the shape of the touch electrodes disposed on the panel according to the aspect.

FIG. 7 is a drawing simplifying the touch electrode arrangement of the mixed-type panel according to the aspect.

FIG. 8 is a drawing explaining the process of recognizing a touch by acquiring a touch-sensing value in the mixed-type panel according to the aspect.

FIG. 9 is a drawing explaining a method for setting a test region of a ghost touch according to the aspect.

FIG. 10 is a first example drawing explaining a method for adjusting a touch reliability value according to the aspect.

FIG. 11 is a second example drawing explaining a method for adjusting a touch reliability value according to the aspect.

FIG. 12 is a third example drawing explaining a method for adjusting a touch reliability value according to the aspect.

FIG. 13 is a flowchart of a touch-sensing method according to the aspect.

FIG. 14 is a detailed flowchart of a ghost touch removal algorithm according to the aspect.

### DETAILED DESCRIPTION

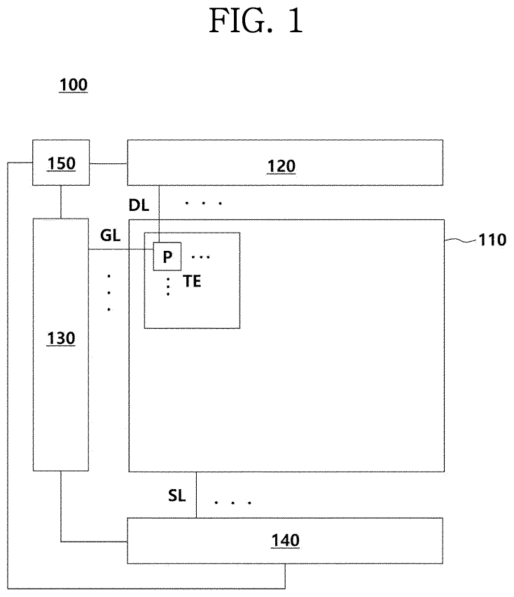

FIG. 1 is a configuration diagram of a display device according to an aspect.

As illustrated in FIG. 1, the display device 100 according to the aspect may perform a display function and a touch-sensing function. The display device 100 according to the aspect may comprise a flat display panel such as a liquid crystal display (LCD) panel or an organic light-emitting diode (OLED) panel.

Referring to FIG. 1, the display device 100 may comprise a panel 110, a data driving circuit 120, a gate driving circuit 130, a touch-sensing circuit 140, a timing controller 150, etc.

The panel 110 may comprise a plurality of data lines DL connected to the data driving circuit 120 and a plurality of gate lines GL connected to the gate driving circuit 130. In addition, a plurality of pixels P corresponding to the intersections of a plurality of data lines DL and a plurality of gate lines GL may be defined on the panel 110.

The panel 110 may comprise a display panel and a touch panel (TSP). The display panel and the touch panel may share some components with each other. For example, a plurality of touch electrodes TE may be a component of the display panel (e.g., a common electrode for applying a common voltage) and may be a component of the touch panel (a touch electrode for detecting a touch) at the same time. In addition, the panel 110 may be an in-cell type panel in which some components of the display panel and the touch panel are shared with each other, but is not limited thereto.

The data driving circuit 120 may receive a data control signal from the timing controller 150 and supply a data signal to the data line DL to display an image on each pixel P of the panel 110.

The gate driving circuit 130 may receive a gate control signal from the timing controller 150 and sequentially supply a scan signal to the gate line GL to turn on or off a transistor located in each pixel P.

The touch-sensing circuit 140 may apply a touch driving signal to all or part of a plurality of touch electrodes TE connected to the touch-sensing line SL.

In order for the touch-sensing circuit 140 to apply a touch driving signal to all or part of a plurality of touch electrodes TE, a touch-sensing line SL connected to each of the plurality of touch electrodes TE is required. Accordingly, a touch-sensing line SL connected to each of a plurality of touch electrodes TE and transmitting a touch driving signal may be disposed on the panel 110 in a first direction (e.g., vertical direction) or a second direction (e.g., horizontal direction).

Meanwhile, the display device 100 may employ an electrostatic touch method that recognizes the proximity or touch of an object by detecting a change in electrostatic capacitance through the touch electrode TE. This electrostatic touch method may comprise a mutual capacitance touch method and a self-capacitance touch method. The aspect may apply the electrostatic touch method, but is not limited thereto.

Meanwhile, the display device 100 may time-divisionally drive the touch electrodes TE by distinguishing the display time section and the touch time section. For example, the touch-sensing circuit 140 of the display device 100 may not apply a driving signal to all or part of the touch electrode TE in the section where the data signal is supplied.

In addition, the display device 100 may drive the touch electrode TE without distinguishing the display time section and the touch time section. For example, the touch-sensing circuit 140 of the display device 100 may apply a driving signal to all or part of the touch electrode TE in the section where the data signal is supplied.

The timing controller 150 may supply various control signals to the data driving circuit 120, the gate driving circuit 130, and the touch-sensing circuit 140. The timing controller 150 may drive the data driving circuit 120, the gate driving circuit 130, and the touch-sensing circuit 140 according to each timing. To this end, the timing controller 150 may transmit a data control signal DCS that controls the data driving circuit 120 to supply a data voltage to each pixel P. The timing controller 150 may transmit a gate control signal GCS to the gate driving circuit 130. The timing controller 150 may transmit a sensing signal to the touch-sensing circuit 140. The timing controller 150 may also perform other control functions.

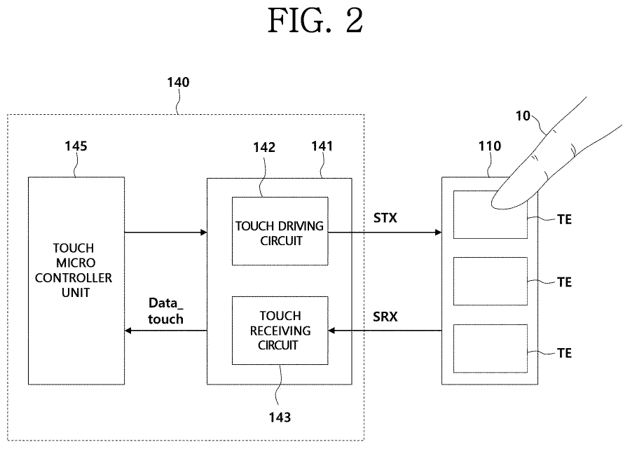

FIG. 2 is a configuration diagram of a touch-sensing circuit according to an aspect.

Referring to FIG. 2, the touch-sensing circuit 140 may comprise a readout circuit 141, a touch microcontroller unit 145, etc. The touch microcontroller unit 145 may be called a microcontroller, a touch microcontroller, a controller, etc.

The readout circuit 141 may comprise a touch driving circuit 142, a touch receiving circuit 143, etc. The touch-sensing circuit 140 may transmit a touch driving signal STX to the touch electrode TE of the panel 110 through the touch driving circuit 142. The touch-sensing circuit 140 may receive a touch-sensing signal SRX from the touch electrode TE of the panel 110 through the touch receiving circuit 143.

The readout circuit 141 may receive a touch-sensing signal SRX having a size corresponding to the amount of change in electrostatic capacity in the form of current or voltage. The readout circuit 141 may demodulate the touch-sensing signal SRX to generate touch data Data_touch and transmit it to the touch microcontroller unit 145. The touch data Data_touch may be expressed as a touch-sensing value.

The touch microcontroller unit 145 may receive touch data to determine the touch or proximity of the object 10 to the panel 110, and control the operation of the readout circuit 141.

The touch driving circuit 142 of the readout circuit 141 may transmit an uplink signal UL to the stylus pen through the touch electrode TE of the panel 110. When the stylus pen touches the panel 110 comprising the touch electrode TE or approaches within a certain distance, the stylus pen may receive the uplink signal UL. The uplink signal UL may be transmitted from part or all of the panel 110 to the stylus pen.

The touch receiving circuit 143 of the touch-sensing circuit 140 may receive a downlink signal DL from the stylus pen through the touch electrode TE. The downlink signal DL may be transmitted to the touch electrode TE located at the point where the stylus pen touches or approaches.

The touch-sensing circuit 140 may determine whether there is a touch, a touch location, touch intensity, a touch interval, etc. according to the change in electrostatic capacity of the touch electrode TE according to the touch or approach of the object.

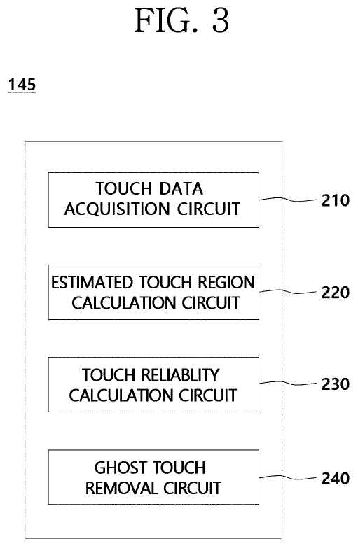

FIG. 3 is a configuration diagram of a touch microcontroller unit according to an aspect.

Referring to FIGS. 2 and 3, the touch microcontroller unit 145 may comprise a touch data acquisition circuit 210, an estimated touch region calculation circuit 220, a touch reliability calculation circuit 230, a ghost touch removal circuit 240, etc.

The touch data acquisition circuit 210 may acquire a touch-sensing value corresponding to the amount of electrostatic capacity change formed on the touch electrode TE. A mixed-type panel having a combination of different patterns may have a constant touch characteristic.

For example, when touch electrodes TE with different sizes are used and the electrical connection relationship of each touch electrode TE and the electrical connection relationship of the touch-sensing line are set to a specific pattern, a ghost touch phenomenon may occur due to a diagonal touch.

When touch electrodes TE having the same size are repeatedly disposed and a touch is sensed through one node of each touch electrode TE, the change in electrostatic capacity of each touch electrode TE may be sensed individually. However, when a plurality of touch electrodes are connected to one touch-sensing line, a touch-sensing value indicating that a touch occurred at a location other than the actual touch location may be acquired.

When an existing touch processing method is used as is without considering a size of a region of the touch electrode TE in the touch panel and the electrical connection relationship of the touch electrode TE, when two touches are performed in the surrounding diagonal direction, a problem may occur in which three or four touches, etc., are recognized instead of the two touches that were actually performed due to ghost touches.

To solve this problem, the touch reliability may be determined for some of the touches in the estimated touch regions based on the touch-sensing values, and ghost touches may be removed so that touch data may be acquired only for the actual touched region or location.

The estimated touch region calculation circuit 220 of the touch microcontroller unit 145 may set a test region of a ghost touch and calculate the estimated touch regions based on the touch-sensing values within the test region of the ghost touch.

The estimated touch region calculation circuit 220 may define touch regions having a touch-sensing value higher than the reference touch-sensing value as estimated touch regions based on the touch-sensing value, and perform ghost touch removal. In general, the ghost touch phenomenon does not occur for one touch, and the estimated touch regions may be acquired when two or more touches-for example, two touches in a diagonal direction-are performed. In a mixed-type touch pattern, a structure electrically connected to other touch electrodes may be provided, so that touch-sensing values may be acquired even at points where actual touches do not occur.

The reference touch-sensing value may be a preset threshold value, and the touch microcontroller 145 may change the reference threshold value as needed.

The estimated touch region calculation circuit (220) may recognize a touch region having a value higher than a reference touch-sensing value as having occurred based on the touch-sensing value, and may recognize a touch region having a value lower than the reference touch-sensing value as having not occurred.

The touch reliability calculation circuit 230 may calculate a touch reliability value for each estimated touch region. For example, when the first to fourth touch region are determined to be estimated touch region, a touch reliability value may be individually assigned to each touch region.

The touch reliability calculation circuit 230 may not perform touch reliability calculation when only two diagonal touches occur or only one touch occurs.

The touch reliability calculation circuit 230 may perform touch reliability value calculation when it is determined that three touches have occurred, as a situation in which the surrounding region is affected by the diagonal touch. Considering the structural characteristics of one touch electrode, only up to two touches may be identified within the array. Accordingly, two actual touches in the diagonal direction and one ghost touch may occur. In this instance, the touch reliability calculation circuit 230 may perform an operation to increase the touch reliability value for two touches located in the diagonal direction among the estimated touch region, or to decrease the touch reliability value for one ghost touch. The touch microcontroller unit 145 may define this operation as a first case (CASE 1) and perform a reliability determination algorithm.

The readout circuit 141 of the touch-sensing circuit 140 may receive the touch-sensing values of the first touch electrode and the second touch electrode for each frame and transmit them to the touch microcontroller unit 145. The touch microcontroller unit 145 may remove ghost touches by using the touch-sensing values acquired for each frame.

The touch microcontroller unit 145 may compare the touch data of the touch region of the previous frame and the touch data of the estimated touch regions of the current frame, and determine the touch adjacent to the touch region of the previous frame as the actual touch region.

The touch reliability calculation circuit 230 may calculate the coordinate information of the touch region of a first frame and the coordinate information of the estimated touch regions of a second frame. The touch reliability calculation circuit 230 may assign a high touch reliability value to the coordinates of the two estimated touch regions that are closest to the coordinate information of the touch region of the first frame. When three or more touches exist in the test region, it may be considered that the touch location is unlikely to change in the successive frame changes. Therefore, the reliability of a plurality of touch coordinates acquired in the next frame may be determined based on the touch coordinates information existing in the previous frame. In this instance, the two touch coordinates determined as the final touch in the first frame and the touch coordinates of the estimated touch region, which is the candidate region acquired in the second frame, may be compared, and the two closest touches may be determined as actual touches, so that the touch reliability value may be increased. By the same principle, in another aspect, the touch reliability values of the remaining touches except for the two closest touches may be decreased. When there are a plurality of estimated touch region, the touch reliability values may be differentiated and increased or decreased in order of distance from the coordinates of the previous frame.

The touch microcontroller unit 145 may acquire vector information by comparing the coordinates of the touch region of the previous frame and the coordinates of the estimated touch regions of the current frame, and may determine a touch of the estimated touch regions with a different touch direction as a ghost touch.

The touch reliability calculation circuit 230 may calculate the coordinate information of the touch region of the first frame and the coordinate information of the estimated touch regions of the second frame. The touch reliability calculation circuit 230 may calculate the touch movement direction using the coordinate information of the touch region of the first frame and the coordinate information of the estimated touch regions of the second frame, and may assign a touch reliability value based on the touch movement direction. The touch reliability calculation circuit 230 may backtrack the touch coordinates of the previous frame based on the touch coordinates that change continuously for each frame, and may assign a high touch reliability value to a touch with a high possibility of existence.

The touch microcontroller unit 145 may adjust the touch reliability value of each estimated touch region, and may determine touches in touch regions with a low touch reliability value as ghost touches and remove it.

The ghost touch removal circuit 240 may determine ghost touches based on a touch reliability value and perform touch-sensing by not recognizing a ghost touch. In this instance, even when the readout circuit 141 receives the touch-sensing signal and the touch microcontroller 145 acquires the touch-sensing value, it may be understood that the point or region where the actual touch occurred is accurately determined through data post-processing through internal calculation.

When two or more diagonal touches are performed on a panel having a mixed-type pattern, there is a high probability that a ghost touch will occur. Accordingly, the touch reliability value may be determined to effectively remove the ghost touch and improve the touch performance.

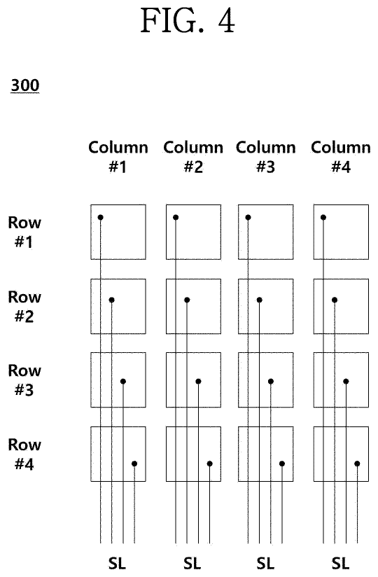

FIG. 4 is a diagram explaining the shape of touch electrodes disposed on a panel.

Referring to FIG. 4, a plurality of touch electrodes having the same shape may be disposed separately on a panel 300.

In this instance, one touch-sensing line SL may be electrically connected to each touch electrode. Since the touch-sensing value may be acquired from each touch electrode, accurate touch calculation may be possible.

However, to perform touch-sensing for all touch electrodes, the cost for manufacturing touch nodes increases rapidly, and the wirings of touch-sensing lines SL becomes complicated. For example, when the size of the touch electrodes is reduced to improve the resolution of touch-sensing, the number of touch-sensing lines SL may increase proportionally.

For example, when touch electrodes are disposed in N columns (N is a natural number greater than or equal to 2) and M rows (M is a natural number greater than or equal to 2), N*M touch nodes and touch-sensing lines SL are required.

In the case of FIG. 4, a total of 16 touch nodes and touch-sensing lines SL are required by using 4 columns Column #1˜#4 and 4 rows Row #1˜#4.

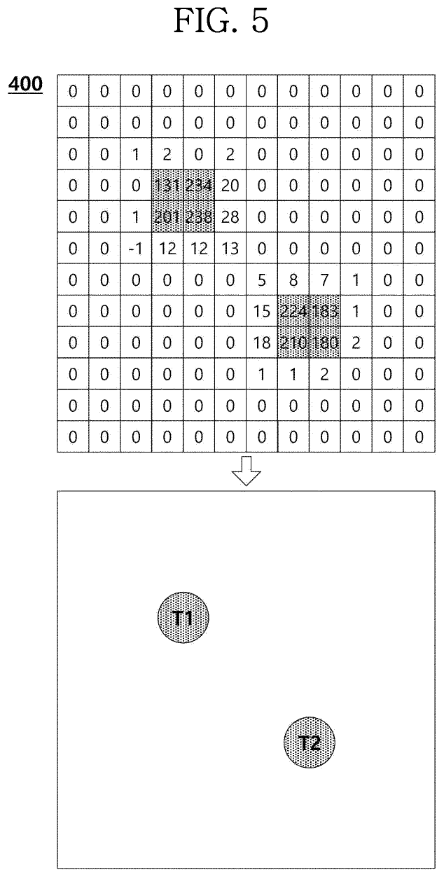

FIG. 5 is a diagram explaining a process of recognizing a touch by acquiring a touch-sensing value from a panel.

Referring to FIG. 5, a panel 400 having 144 touch nodes may sense a touch by acquiring a touch-sensing value for each touch electrode.

For example, when the size of the touch-sensing value is 100 or greater, it may be recognized that a touch has occurred and when a standard touch-sensing value is set, two touch regions T1 and T2 may exist.

Although the panel 400 does not cause a ghost touch phenomenon, the number of touch-sensing lines and the cost of manufacturing touch nodes increase as described above.

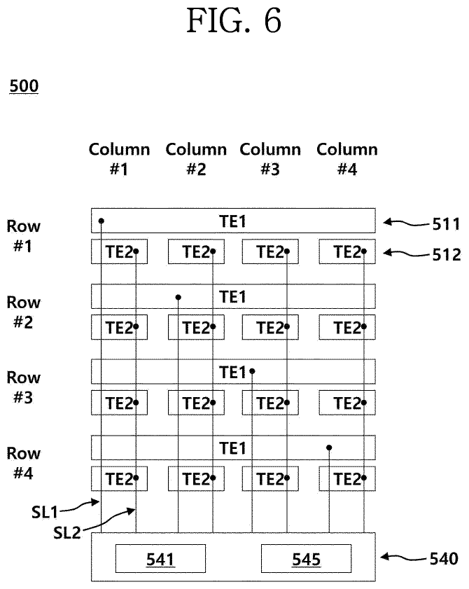

FIG. 6 is a drawing explaining the shape of the touch electrodes disposed on the panel according to the aspect.

Referring to FIG. 6, a mixed-type panel 500 may comprise a plurality of touch electrodes having different sizes or shapes.

The panel 500 may comprise a first touch electrode TE1 having a first region 511 and second touch electrodes TE2 each having a second region 512. The first touch electrode TE1 and the second touch electrodes TE2 may be a set of a plurality of touch electrodes. The size of the first region 511 of the first touch electrode TE1 may be greater than the size of the second regions 512 of the second touch electrodes TE2.

The first touch electrode TE1 may be electrically connected to a first touch-sensing line SL1, and the second touch electrode TE2 may be electrically connected to a second touch-sensing line SL2. The second touch electrodes TE2 may form nodes that is be in contact with the second touch-sensing line SL2, and may have an electrical connection relationship with other second touch electrodes through the nodes.

Each touch electrode TE1 and TE2 of the panel 500 may transmit a touch-sensing signal to a readout circuit 541 by the touch-sensing lines SL1 and SL2, and the touch-sensing values may be acquired and the touch regions may be calculated based on the touch-sensing signals by the microcontroller unit 545.

The touch-sensing circuit 540 may acquire a first touch-sensing value acquired from the first touch electrode TE1 through the first touch-sensing line SL1, and may acquire a second touch-sensing value acquired from the second touch electrode TE2 through the second touch-sensing line SL2. The touch-sensing circuit 540 may calculate estimated touch regions using at least one or more of the first touch-sensing value or the second touch-sensing value.

The touch-sensing circuit 540 may selectively receive signals transmitted by the touch-sensing lines SL1 and SL2, for example, the first touch-sensing value or the second touch-sensing value, by a multiplexer (not illustrated), but is not limited thereto.

The microcontroller unit 545 may determine some of the estimated touch regions as ghost touches and remove them. Here, the meaning of ‘removal’ may be understood as calculating touch coordinates or performing subsequent operations on touch occurrence only for regions where actual touches occur by correcting touch data or not recognizing touch data.

The aspect is not limited to the method described in FIG. 6, and the arrangement order of the first and second touch electrodes TE1 and TE2 may be changed, or designed in different sizes and shapes.

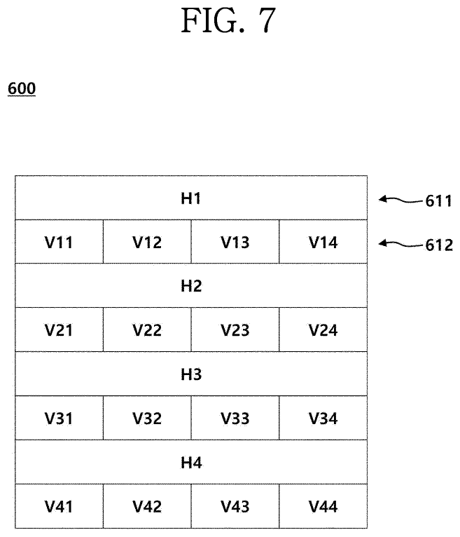

FIG. 7 is a drawing simplifying the touch electrode arrangement of the mixed-type panel according to the aspect.

Referring to FIG. 7, the mixed-type panel 600 may comprise a first touch electrode H1 formed long in the horizontal direction, a plurality of second touch electrodes V11, V12, V13 and V14 formed short in the horizontal direction, etc.

The first touch electrode H1 may have a size of a first region 611, and each of the second touch electrodes V11, V12, V13 and V14 may have a size of a second region 612, and the size of the first region 611 may be greater than the size of the second region 612.

The mixed-type panel 600 may have a plurality of touch electrodes disposed crosswise and each of plurality of touch electrodes may have the same size as a size of the first touch electrode H1 and the second touch electrodes V11, V12, V13 and V14. The first touch electrode H1 and the second touch electrode V11, V12, V13 and V14 may form one array.

The mixed-type panel 600 may comprise a first array, a second array, a third array, and a fourth array. Four arrays are illustrated in the drawing, but more arrays may be provided.

The first array may be formed by one long touch electrode H1 in one direction, for example, a horizontal direction, and four short touch electrodes V11, V12, V13 and V14 in one direction. The second array may be formed by touch electrodes H2, V21, V22, V23 and V24, the third array may be formed by touch electrodes H3, V31, V32, V33 and V34, and the fourth array may be formed by touch electrodes H4, V41, V42, V43 and V44.

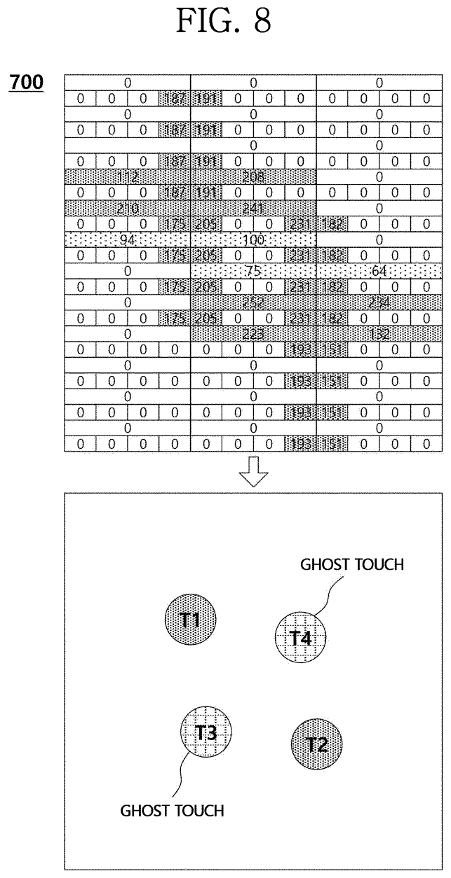

FIG. 8 is a drawing explaining the process of recognizing a touch by acquiring a touch-sensing value in the mixed-type panel according to the aspect.

Referring to FIG. 8, depending on the characteristics of the mixed-type panel 700, the touch-sensing circuit may recognize that a touch has occurred due to a ghost touch even at a point where an actual touch has not occurred.

The mixed-type panel 700 is a mixture of long touch electrodes and short touch electrodes. In this instance, in the long touch electrodes, a touch-sensing signal may be generated equally within one touch electrode at other locations in addition to the point where an actual touch has occurred.

The short touch electrodes may generate a touch-sensing signal equally even at a point where an actual touch has not occurred because each touch electrode shares a touch-sensing line by a contact node.

That is, when two diagonal touches are performed at adjacent locations in the mixed-type panel 700, a ghost phenomenon may occur at a point where an actual touch has not occurred. For example, a touch-sensing value may be received from ghost touch region T3 and T4 other than touch regions T1 and T2 where an actual touch was performed.

Since the touch-sensing circuit cannot distinguish between the actual touch and the ghost touch, it is necessary to recognize only the actual touch using a ghost removal algorithm, etc.

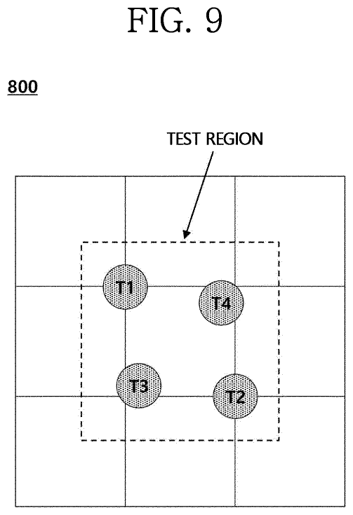

FIG. 9 is a drawing explaining a method for setting a test region of a ghost touch according to the aspect.

Referring to FIG. 9, the panel 800 may be divided into nine arrays, and the touch region may exceed the boundaries of the arrays. In this instance, for accurate calculation, it is necessary to redefine a test region of a ghost touch and apply the ghost touch removal algorithm without performing touch calculation based on the arrays.

For example, the test region of the ghost touch needs to be set wider than the range formed by the first to fourth touch region T1, T2, T3 and T4. The setting of the test region of the ghost touch may be implemented in a rectangular or square shape (see dotted line). In addition, it may be implemented in various aspects, such as setting it as a circle based on the center point of the first to fourth touch region, or calculating and setting the maximum distance based on the outermost touch region.

The test region of the ghost touch may be set to be slightly greater than the set boundary (see dotted line) for a plurality of regions having a touch-sensing value greater than the reference touch-sensing value.

When the test region of the ghost touch is set, the ghost touch algorithm is not applied to the entire region of the panel, so that the operation speed may be improved.

FIG. 9 is for illustrating a method for setting a test region of a ghost touch according to an aspect, and the shape and setting method of the test region are not limited thereto.

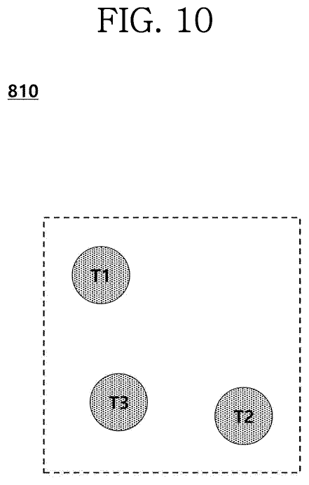

FIG. 10 is a first exemplary drawing explaining a method for adjusting a touch reliability value according to an aspect.

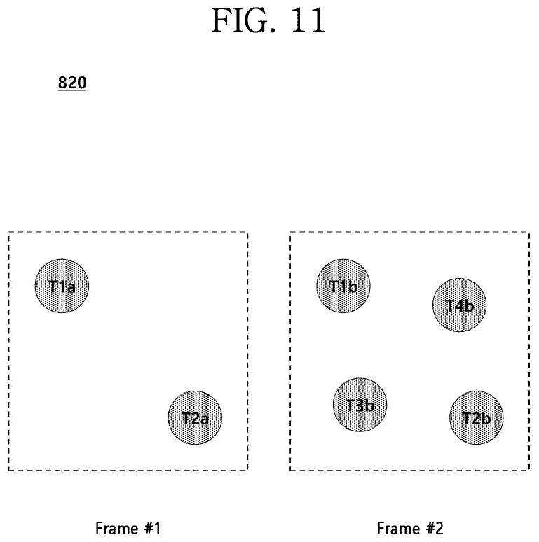

FIG. 11 is a second exemplary drawing explaining a method for adjusting a touch reliability value according to an aspect.

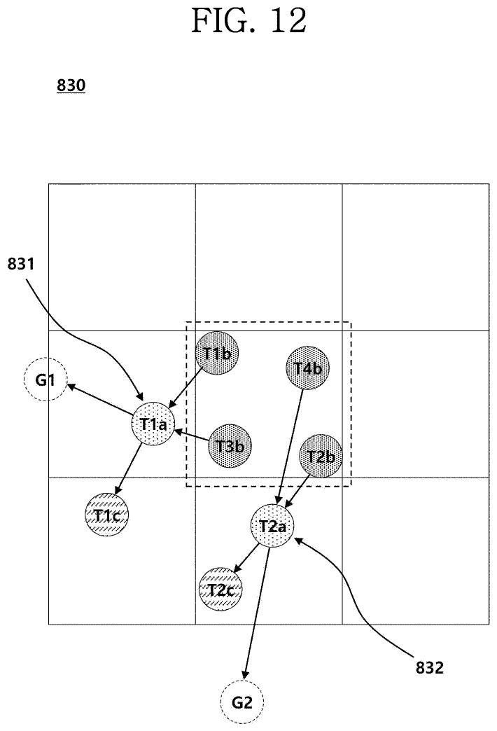

FIG. 12 is a third exemplary drawing explaining a method for adjusting a touch reliability value according to an aspect.

Referring to FIGS. 10 to 12, the adjustment of a touch reliability value may be performed in various ways depending on the situation.

As illustrated in FIG. 10, a first case 810 of a method for adjusting a touch reliability value may be a touch reliability test method in the case where three touches exist within the test region. It may be understood that two touches may be identified in one touch array due to the structure of the touch panel, and the actual number of touches within the test region does not exceed two.

In the first case 810, when there are three estimated touch regions T1, T2 and T3 within the test region of the ghost touch (see dotted line), two touch regions T1 and T2 located diagonally may be determined as actual touches, and the remaining one touch region T3 may be determined as a ghost touch. In this instance, the touch reliability value of the remaining one touch region T3 may be lowered.

As illustrated in FIG. 11, in a second case 820, the reliability of the ghost touch of the current frame Frame #2 may be determined using the information of the previous frame Frame #1. When the number of touches acquired in the first frame Frame #1 is two, the information about the touch regions T1a and T2a may be used to remove the ghost touch in the second frame Frame #2.

The coordinates of the four estimated touch regions T1b, T2b, T3b and T4b acquired in the second frame Frame #2 may be calculated and compared with the coordinates of the two actual touch regions T1a and T2a acquired in the first frame Frame #1, so that the estimated touch regions T1b and T2b existing in the adjacent location may be determined as actual touches. In this instance, the estimated touch regions T3b and T4b may be determined as ghost touches and the touch reliability value may be lowered.

When there are three or more touches in the test region, and when there are two touches in the same test region in the previous frame, the two closest touches may be likely to be actual touches. In this instance, the reliability value of the corresponding touch region may be increased or the reliability value of the remaining touch region may be decreased, so that the ghost touch may be removed.

As illustrated in FIG. 12, in a third case 830, when there are touches of previous frames in the same test region based on the movement of the object, the coordinate information of the previous frames may be traced back to remove the ghost touch. For example, when the displacement value of the object touch movement is large or the speed of the object movement is fast, the test region may change.

In the third case 830, vector information may be utilized to trace the touch coordinates of the previous frames. The vector information comprising direction information may be acquired for the coordinates of the four touch regions T1b, T2b, T3b and T4b of the current frame and the two touch coordinates 831 and 832 of the previous frame, i.e., the second frame. In the case where the vector directions of the two touch coordinates 831 and 832 of the second frame and the two touch regions T1c and T2c of the previous frame, i.e., the third frame, are similar in three consecutive frames, the estimated touch regions T1b an T2b may be determined as an actual touch, and the coordinate information G1 and G2 outside the array may be determined as ghost touches and that an actual touch did not occur.

For example, for the estimated touch regions T1b, T2b, T3b and T4b of the third frame, the vector value may be acquired using the coordinate information of the actual touch regions T1a and T2a of the second frame, so that direction information may be acquired.

The vector value may be acquired by the touch regions T1c and T2c of the first frame and the touch regions T1a and T2a of the second frame, so that the direction information and the degree of separation between the second and third frames may be acquired.

In contrast, for the estimated touch regions T3b and T4b where the ghost touches occurred, the vector information acquired between the second and third frames-for example, the vector information acquired by the touch regions T3b and T1a or the vector information acquired by the touch regions T4b and T2a-may be determined to be significantly different from the direction of the vector information acquired between the first and second frames-for example, the vector information acquired by the touch regions T1a and T1c or the vector information acquired by the touch regions T2a and T2c.

When there are three or more touches in the test region, and when the touches in the same test region of the previous frame are not two, the touch information of the previous frames may be traced back to increase the reliability of the touch regions likely to exist along the time axis, or decrease the reliability of the remaining touches region to remove the ghost touches.

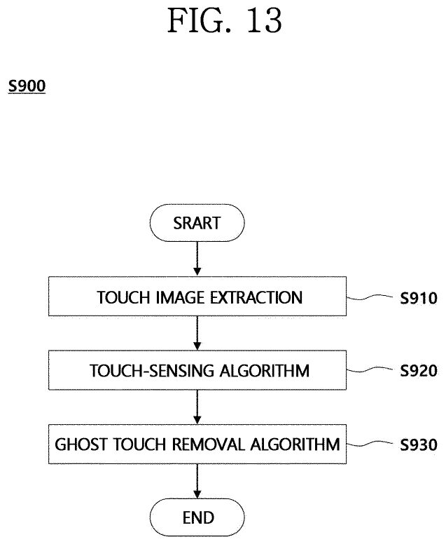

FIG. 13 is a flowchart of a touch-sensing method according to an aspect.

Referring to FIG. 2 and FIG. 13, the touch-sensing method (S900) may comprise a touch image extraction step (S910), a touch-sensing algorithm step (S920), a ghost touch removal algorithm step (S930), etc.

In the touch image extraction step (S910), a touch-sensing signal may be acquired in the form of an analog signal for each touch electrode on the panel, and the analog signal may be converted to a digital value to extract a touch image. A deviation between the raw image data and the base image data may be acquired, and the deviation may be defined as a touch image. A touch-sensing value Data_touch of 0 or more may be acquired for each array.

In the touch-sensing algorithm step (S920), an internal operation may be performed to determine whether there is a touch, touch coordinates, etc. For example, the microcontroller unit 145 may acquire touch-sensing values Data_touch as data of 0 or more for each touch electrode or array and perform an operation. The microcontroller unit 145 may determine that touches has occurred in regions having the touch-sensing values Data_touch greater than or equal to a reference touch-sensing value, and may calculate the intensity, location, etc., of the touches based on the touch-sensing values Data_touch. The microcontroller unit 145 may determine that the touches have not occurred in regions having the touch-sensing values less than or equal to a reference touch-sensing value, but is not limited thereto.

In the ghost touch removal algorithm step (S930), to prevent misrecognition as a touch even when the proximity of an actual object or reception of a signal has not occurred, ghost touches may be determined and an operation for removing the ghost touches may be performed.

The microcontroller unit 145 may sense and process actual touches and ghost touches by performing a preset touch reliability determination operation using the touch-sensing values Data_touch.

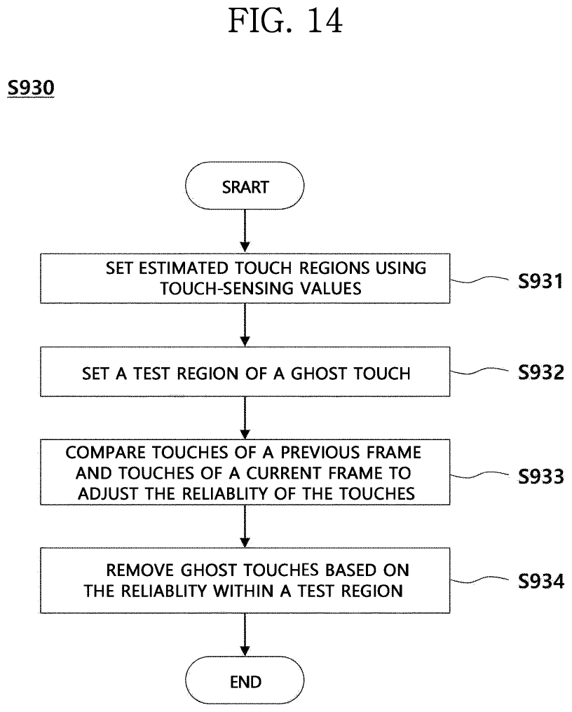

FIG. 14 is a detailed flowchart of a ghost touch removal algorithm according to an aspect.

Referring to FIG. 2, FIG. 13, and FIG. 14, the ghost touch removal algorithm step (S930) may comprise an estimated touch region setting step (S931), a test region of a ghost touch setting step (S932), a touch reliability value calculation step (S933), a ghost touch removal step (S934), etc.

The ghost touch phenomenon may occur in a panel where touch electrodes of first patterns and second patterns are mixed. The touch-sensing circuit 140 may acquire the touch-sensing values Data_touch from a panel in which one touch electrode having the first patterns and a first touch-sensing line are connected in a one-to-one correspondence. The touch-sensing circuit 140 may acquire the same touch-sensing value Data_touch from the panel by connecting a plurality of touch electrodes having the second patterns with a common node by the second touch-sensing line.

In the estimated touch region setting step (S931), the touch-sensing values Data_touch may be acquired from a panel where ghost touches occur, the touch-sensing values Data_touch may be compared with a reference touch-sensing value, and regions having the touch-sensing values Data_touch greater than or equal to the reference touch-sensing value may be set as estimated touch regions. The estimated touch regions may be a plurality of regions, and for example, may be two or more touch regions. The estimated touch regions may comprise two to four touch regions, but is not limited thereto.

In the setting step of the test region of the ghost touch (S932), an outer edge or a boundary (see the dotted line in FIG. 9) or a wider region that may comprise a boundary may be set as a test region of a ghost touch based on the estimated touch regions.

In the touch reliability value calculation step (S933), the touches of the previous frame and the touches of the current frame may be compared, and the reliability of the touches may be calculated and adjusted. In the touch reliability value calculation step (S933), the touch reliability value may be calculated and adjusted for each estimated touch region.

In the touch reliability value calculation step (S933), when the estimated touch regions have three regions, the touch-sensing circuit 140 may decrease the touch reliability value of the remaining one touch region other than the two diagonal touch regions. For example, when the two touch regions in a diagonal direction are given a touch reliability value of 10, the touch reliability value may be decreased for the remaining one touch region to be given a touch reliability value of 5, but is not limited thereto.

In the touch reliability value calculation step (S933), the touch-sensing circuit (140) compares the touch regions of the previous frame with the estimated touch regions of the current frame, and the touch reliability values of the estimated touch regions that did not exist in the previous frame may be decreased.

In the touch reliability value calculation step (S933), the touch-sensing circuit 140 may calculate the movement direction of the touches based on the coordinate values of the touch regions of the previous frame and the coordinate values of the estimated touch regions of the current frame, and the touch reliability value of the estimated touch regions having a different movement direction may be decreased.

In the ghost touch removal step (S934), the ghost touches may be removed based on the reliability within the test region. In the ghost touch removal step (S934), the upper two touch regions with high touch reliability values in the estimated touch regions may be determined as actual touches, and the remaining touch region may be recognized as a ghost touch, and the touch-sensing value Data_touch may be updated to 0.

FIG. 14 is for explaining the operation of the ghost touch removal algorithm according to the aspect, and may comprise various modified aspects, such as some steps being omitted or the order of operations being changed.

1. A touch-sensing circuit, comprising:
a readout circuit configured to acquire a first touch-sensing value from a first touch electrode having a first region and acquire a second touch-sensing value from second touch electrodes, each of the second touch electrodes having a second region; and
a touch microcontroller unit for calculating estimated touch regions based on the first touch-sensing value and the second touch-sensing value,
wherein the touch microcontroller unit is configured to determine some of the estimated touch regions as ghost touches and remove the ghost touches.

2. The touch-sensing circuit of claim 1, wherein a size of the first region is greater than a size of the second region, and
wherein a plurality of touch electrodes are disposed crosswise, each having a same size as a size of the first touch electrode and the second touch electrodes.

3. The touch-sensing circuit of claim 1, wherein the first touch electrode is electrically connected to a first touch-sensing line, and the second touch electrode is electrically connected to a second touch-sensing line, and
wherein the second touch electrodes have an electrical connection relationship with other second touch electrodes by the second touch-sensing line.

4. The touch-sensing circuit of claim 1, wherein the estimated touch regions comprises two to four touch region.

5. The touch-sensing circuit of claim 1, wherein the touch microcontroller unit is configured to set a test region of a ghost touch and calculate the estimated touch regions based on touch-sensing values within the test region of the ghost touch.

6. The touch-sensing circuit of claim 1, wherein the readout circuit is configured to receive touch-sensing values of the first touch electrode and the second touch electrodes for each frame and transmit the touch-sensing values to the touch microcontroller unit, and
wherein the touch microcontroller unit is configured to remove the ghost touches by using the touch-sensing values acquired for each frame.

7. The touch-sensing circuit of claim 6, wherein the touch microcontroller unit is configured to compare touch data of touch regions of a previous frame and touch data of the estimated touch regions of a current frame, and determine touches adjacent to the touch regions of the previous frame as actual touch regions.

8. The touch-sensing circuit of claim 1, wherein the touch microcontroller unit is configured to compare coordinates of touch regions of the previous frame and coordinates of the estimated touch regions of the current frame to acquire vector information, and determine touches of the estimated touch regions with a different touch direction as ghost touches.

9. The touch-sensing circuit of claim 1, wherein the touch microcontroller unit is configured to determine two touch regions located in a diagonal direction as actual touches when the estimated touch regions has three regions.

10. The touch-sensing circuit of claim 1, wherein the touch microcontroller unit is configured to adjust each touch reliability value of the estimated touch regions and determine touches in touch regions with a low touch reliability value as ghost touches to removes the ghost touches.

11. A touch-sensing method, comprising:
acquiring touch-sensing values from a panel in which touch electrodes of a first pattern and a second pattern are mixed;
comparing the touch-sensing values with a reference touch-sensing value to set regions having sensing values higher than the reference touch-sensing value as estimated touch regions;
assigning a touch reliability value to each of the estimated touch regions; and
determining touch regions in which ghost touches has occurred based on the touch reliability values of the estimated touch regions.

12. The touch-sensing method of claim 11, wherein one touch electrode having the first pattern and a first touch-sensing line are connected in a one-to-one correspondence to acquire a touch-sensing value, and a plurality of touch electrodes having the second pattern are electrically connected with common nodes by the second touch-sensing line to acquire a same touch-sensing value.

13. The touch-sensing method of claim 11, further comprising setting a test region of ghost touches based on the estimated touch regions.

14. The touch-sensing method of claim 11, further comprising when the estimated touch regions has three regions, decreasing a touch reliability value of the remaining touch region other than the diagonal two touch regions.

15. The touch-sensing method of claim 11, further comprising:
comparing the touch regions of a previous frame with the estimated touch regions of a current frame; and
decreasing the touch reliability values of the estimated touch regions that do not exist in the previous frame.

16. The touch-sensing method of claim 11, further comprising:
calculating a movement direction of touches based on coordinates values of the touch regions of a previous frame and coordinate values of the estimated touch regions of a current frame; and
decreasing the touch reliability values of the estimated touch regions having a different movement direction.

17. The touch-sensing method of claim 11, further comprising:
determining upper two touch regions with high touch reliability values in the estimated touch regions as actual touches; and
recognizing the remaining touch region as a ghost touch to update the touch-sensing value to 0.

18. A touch microcontroller unit, comprising:
a touch data acquisition circuit configured to acquire touch-sensing values from a panel having a combination of different patterns;
an estimated touch regions calculation circuit configured to acquire two or more estimated touch regions having a reference touch-sensing value or higher based on the touch-sensing values;
a touch reliability calculation circuit configured to calculate a touch reliability value for each of the estimated touch regions; and
a ghost touch removal circuit configured to determine ghost touches based on the touch reliability values and performs touch-sensing by not recognizing the ghost touches.

19. The touch microcontroller unit of claim 18, wherein the touch reliability calculation circuit is configured to calculate coordinate information of touch regions of a first frame and coordinate information of estimated touch regions of a second frame, and assign high touch reliability values to the coordinates of two estimated touch regions that are closest to the coordinate information of the touch regions of the first frame.

20. The touch microcontroller unit of claim 17, wherein the touch reliability calculation circuit is configured to calculate coordinate information of touch regions of a first frame and coordinate information of estimated touch regions of a second frame, calculate a touch movement direction using the coordinate information of the touch regions of the first frame and the coordinate information of the estimated touch regions of the second frame, and assign touch reliability values based on the touch movement direction.
